(19) United States
(12) Patent Application Publication
(10) Pub. No.: US 2016/0014518 A1
(43) Pub. Date: Jan. 14, 2016

(54) SPEAKER AND DIAPHRAGM THEREOF

(71) Applicants: SHIH-TUNG LIU, MIAOLI COUNTY (TW); CHUN-TING CHEN, NEW TAIPEI CITY (TW); CHENG-YU HSIEH, TAIPEI CITY (TW)

(72) Inventor: SHIH-TUNG LIU, MIAOLI COUNTY (TW)

(21) Appl. No.: 14/325,418

(22) Filed: Jul. 8, 2014

(51) Int. Cl. H04R 7/02; H04R 9/02; H04R 1/00

(52) U.S. Cl. CPC H04R 7/02; H04R 1/00; H04R 9/02

(57) ABSTRACT

The instant disclosure provides a speaker which includes a support structure, a diaphragm, and a coil. The upper frame of the support structure has an opening formed thereon. The diaphragm is disposed on the upper frame of the support structure and located at the peripheral portions of the opening The diaphragm has a substrate layer and a magnetic layer formed thereon. The coil is disposed on the lower frame of the support structure and opposite to the diaphragm. The coil drives the diaphragm to vibrate for sound generation by electromagnetic induction when an electrical current is introduced through the coil.

### BACKGROUND OF THE INVENTION

1. Field of the Invention

The instant disclosure relates to a speaker and a diaphragm thereof; in particular, to a thin, light speaker, and a magnetic diaphragm thereof.

2. Description of Related Art

Consumer electronic products such as smart phones, smart watches, wristbands, tablets, and notebooks are all trending towards thin appearances and light weight, thus posing much design limitations to the design of speakers in these electronic products. Typically, moving-coil type speakers are among the most commonly applied speakers in these electronic products. The conventional moving-coil type speakers generate electromagnetic induction to drive the diaphragm for sound generation mainly through the arrangement of moving-coil positioning above and magnetic assembly (inner and outer magnets) below. The specific actuation is provided by disposing moving-coil into a gap between the magnets, introducing a current through the moving-coil such that electromagnetic induction is generated in response to magnetism of the magnetic assembly, thus leading to repetitive axial actuation of the diaphragm which leads to sound generation. However, the magnetic assembly of the conventional moving-coil type speakers typically occupies a substantial amount of spaces, and the speakers per se possess an overall bulky body due to the space necessary to allow the moving-coil affixed to the diaphragm to drive the diaphragm axially for sound generation, and the space for magnetic assembly, thus increasing the overall thickness of the speakers and swaying away from the trend of thin appearances and light weight.

To address the above issues, the inventor strives via associated experience and research to present the instant disclosure, which can effectively improve the limitation described above.

### SUMMARY OF THE INVENTION

The object of the instant disclosure is to provide a speaker and a diaphragm which is thin and light.

In order to achieve the aforementioned objects, according to an embodiment of the instant disclosure, a speaker is provided which includes a support structure, a diaphragm, and a coil. The support structure includes an upper frame and a lower frame. The upper frame having portions defining an opening thereon. The diaphragm is disposed on the upper frame of the support structure circumscribed by portions defining the opening The diaphragm has a substrate layer and a magnetic layer formed on a surface of the substrate layer. The coil is disposed on the lower frame. The coil and the diaphragm are arranged opposite to one another and cooperatively define a gap therebetween. The coil and the diaphragm cooperatively generate electromagnetic induction in response to electrical current passing through the coil such that the diaphragm vibrates for sound generation.

The instant disclosure also provides a diaphragm arranged in a speaker. The diaphragm includes a substrate layer and a magnetic layer formed on a surface thereof.

The instant disclosure also provides another diaphragm arranged in a speaker. The diaphragm is a sheet of alloy diaphragm made of iron, chromium, cobalt, neodymium, and boron.

In summary, the speaker of the instant embodiment includes the diaphragm that has the magnetic layer. The diaphragm possesses magnetism which is different from the conventional materials such as paper, plastics or metallic materials used for a diaphragm. Furthermore, unlike the conventional positioning of the moving-coil, in which the moving-coil is positioned above a support frame and attached to a diaphragm while a magnetic assembly is positioned below the support frame, the magnetic diaphragm of the instant disclosure is positioned above the support frame while the coil is positioned below the support frame. With the aforementioned design, the speaker in the instant disclosure saves space, in which the magnetic assembly is no longer necessary. In addition, the diaphragm and the coil are spaced apart with a gap which can be as narrow as possible there-between, which is different from the conventional moving-coil where it is necessary to maintain a large enough space for the moving-coil to lead the vibration of the diaphragm. With the magnetic diaphragm and the corresponding coil of the speaker in accordance with the instant disclosure, the overall thickness of the speaker in the instant disclosure effectively reduced to provide a light and thin design, and space is saved that could once be occupied by the conventional magnetic assembly.

In order to further understand the instant disclosure, the following embodiments and illustrations are provided. However, the detailed description and drawings are merely illustrative of the disclosure, rather than limiting the scope being defined by the appended claims and equivalents thereof

### BRIEF DESCRIPTION OF THE DRAWINGS

FIG. 1 is a perspective view of a speaker in accordance with the instant disclosure;

FIG. 2 is an exploded view of the speaker in accordance with the instant disclosure;

FIG. 3 is a perspective cross-sectional view of the speaker in accordance with the instant disclosure;

FIG. 4 is a cross-sectional view of the speaker in accordance with the instant disclosure; and

FIG. 5 is a detail view of section A in FIG. 4.

### DETAILED DESCRIPTION OF THE PREFERRED EMBODIMENTS

The aforementioned illustrations and detailed descriptions are exemplarities for the purpose of further explaining the scope of the instant disclosure. Other objectives and advantages related to the instant disclosure will be illustrated in the subsequent descriptions and appended drawings.

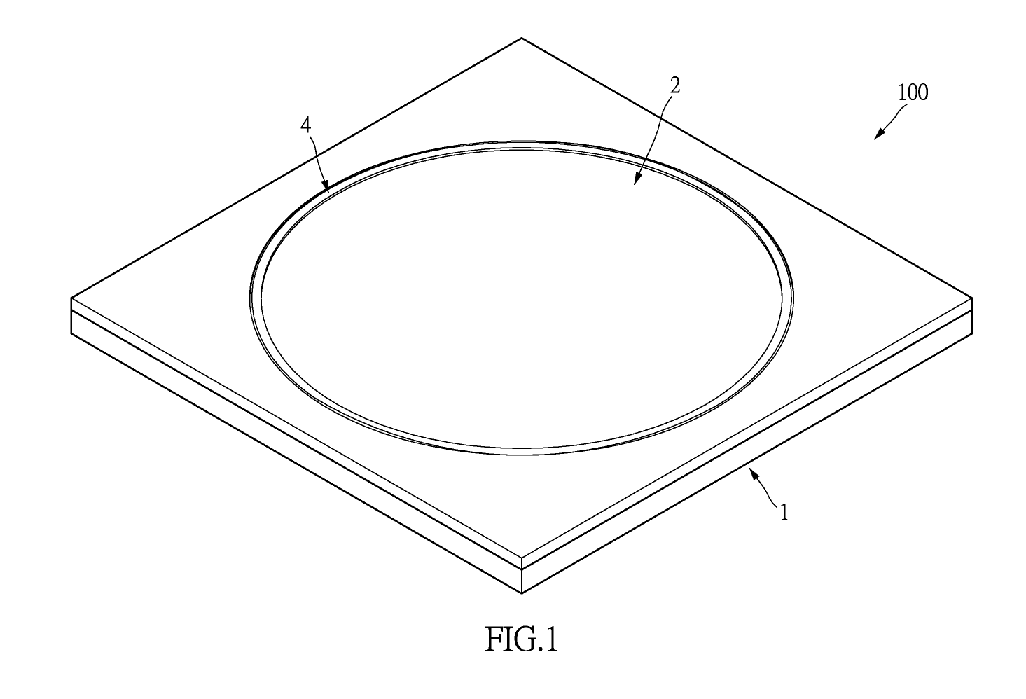

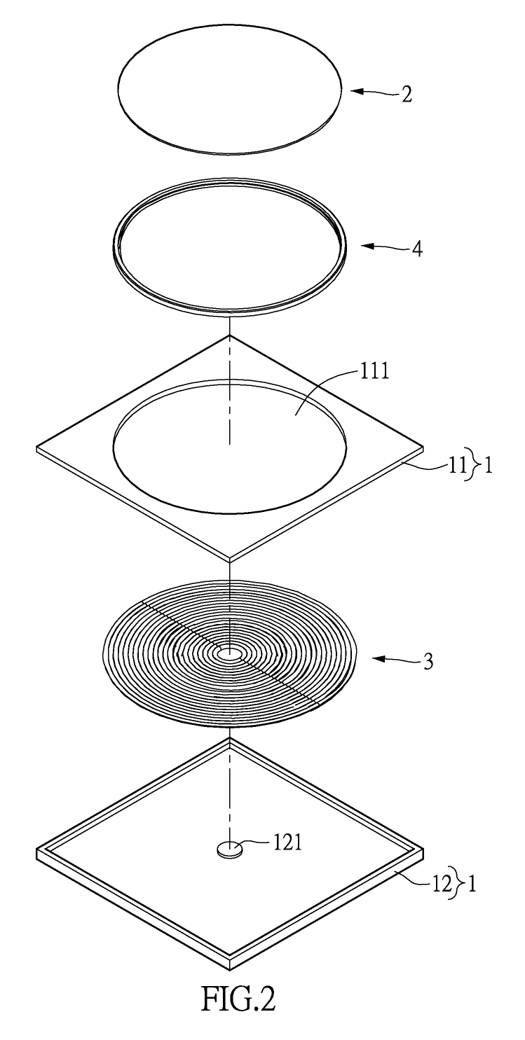

Please refer to FIGS. 1 to 5 as one embodiment of the speaker in the instant disclosure. As shown in FIGS. 1 and 2, the speaker 100 basically includes a support structure 1, a diaphragm 2, and a coil 3.

The support structure 1 is made of insulating materials such as plastic and resembles a flat rectangular appearance. The support structure 1 can further disassembled into two portions, an upper frame 11 and a lower frame 12. The upper frame 11 has an opening 111 formed thereon.

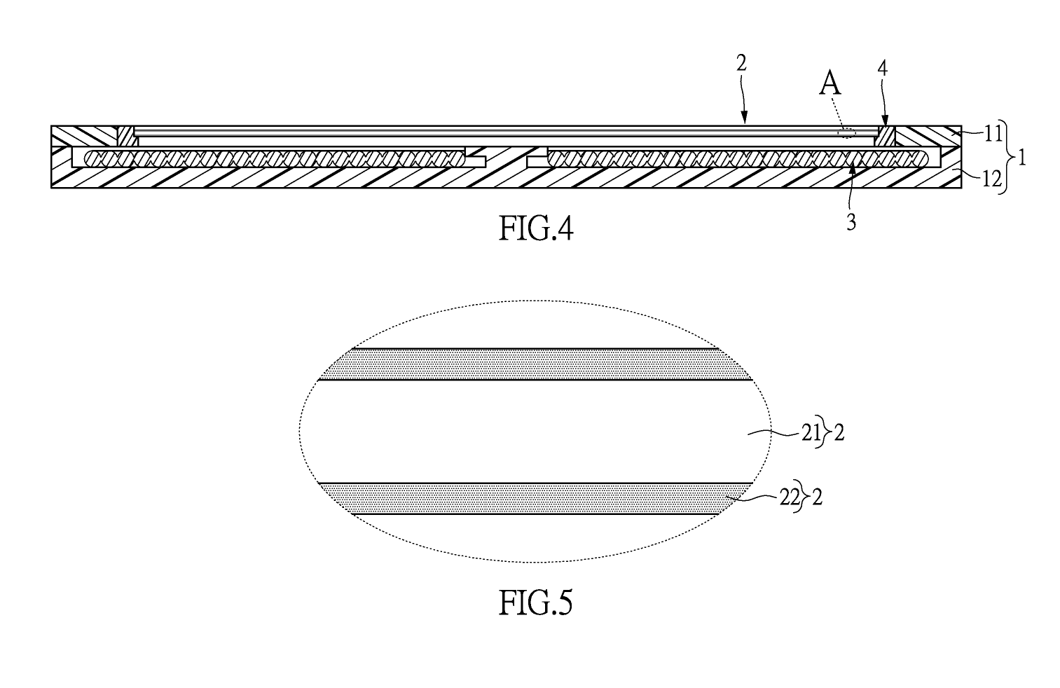

The diaphragm 2 resembles a thin film and is located on the upper frame 11 of the support structure 1 and circumscribed by peripheral portions of the opening 111. As shown in FIGS. 4 and 5, the diaphragm 2 has a substrate layer 21 and a magnetic layer 22 formed on a surface of the substrate layer 21. Specifically, the substrate layer 21 of the diaphragm 2 can be made of one of the following materials such as pulp, cloth, silk, linen, synthetic fiber, ceramics, metal, plastics, or polymers, but not limited to the examples provided herein. The magnetic layer 22 can be made of the following materials such as iron, chromium, cobalt, neodymium, and boron. However, the ratio between the materials of the magnetic layer 22 can be adjusted depending on the design required. Alternatively, the magnetic layer 22 can be formed on the substrate layer 21 such that the diaphragm 2 possess magnetisms by methods of physical vapor deposition (PVD) or chemical vapor deposition (CVP).

In another embodiment, the diaphragm 2 is a sheet of alloy diaphragm made of iron, chromium, cobalt, neodymium, and boron by alloying technique in order to obtain a magnetized diaphragm 2.

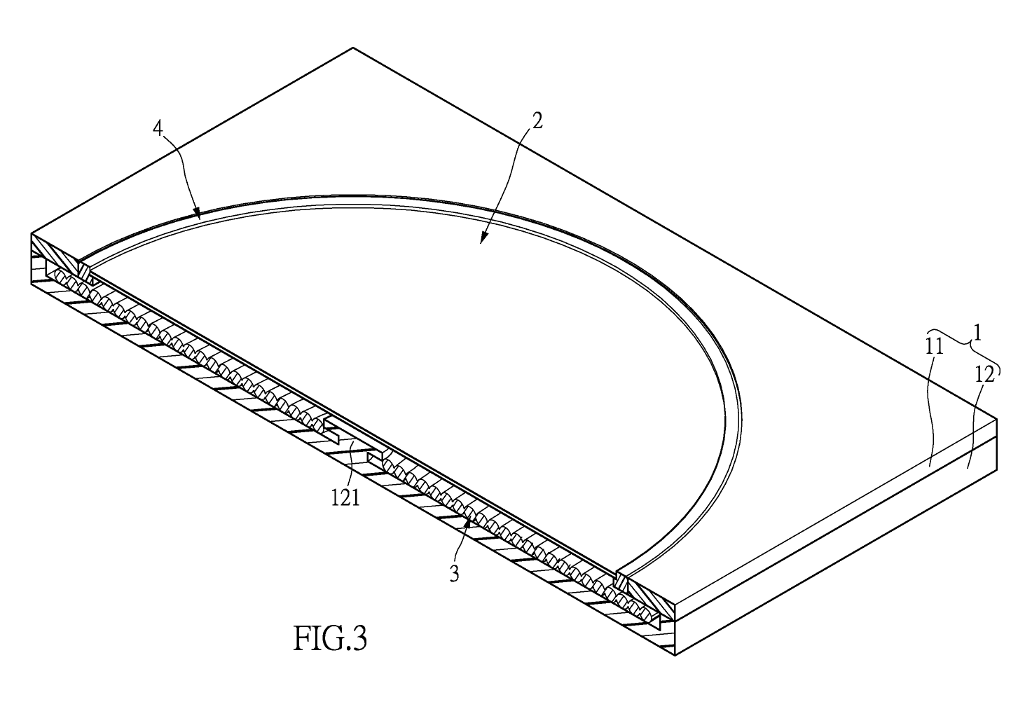

The coil 3 is a planar or flat coil located at the lower frame 12. Specifically, the lower frame 12 of the support structure 1 has a fixing portion 121 formed at a center of the lower frame 12. The coil 3 is fixed onto the lower frame 12 of the support structure 1 via the fixing portion 121. Moreover, the coil 3 and the diaphragm 2 are arranged opposite one another and are correspondingly spaced apart with a gap therebetween as shown in FIGS. 3 and 4. In other words, the coil 3 corresponds to the diaphragm 2 in parallel with a relatively gap of a predetermined metering size there-between. Moreover, the size of the gap can be as narrow as possible such that the diaphragm 2 can vibrate, and the overall thickness of the speaker can be minimized.

The speaker 100 can further include a surround 4. The surround 4 can be made of one of the following flexible materials such as a silicone, cloth, rubber, or foam. Furthermore, the surround 4 abuts the peripheral portions of the diaphragm 2 and peripheral portions of the upper frame 11 that defines the opening 111. In the instant embodiment, the surround 4 is a silicone surround that seals between the peripheral portions of the opening 111 and the diaphragm 2.

When assembling the speaker 100 of the instant embodiment, the coil 3 is disposed on and fixated at the lower frame 12 of the support structure 1. The diaphragm 2 is arranged in the opening 111 with a gap therebetween via fixtures, and the surround materials are then injected into the gap between the peripheral portions of the diaphragm 2 and the opening 111. Once the surround material is solidified, the diaphragm 2 is coupled to the upper frame 11 of the support structure via the surround 4. The upper frame 11 and the lower frame 12 are then glued for completion of assembly.

When the speaker 100 of the instant embodiment is active, electrical current is passed through the coil 3. The coil will change electromagnetic field along with the electrical current phase of the current passing through according to Maxwell's relation, and with the Ampere's right hand rule, thus the direction of the magnetic field is derived. The coil 3 generates an electromagnetic field in response to the current passing through the coil 3, and directly induces electromagnetism along with the magnetized diaphragm 2. Moreover, since opposite charges attract and same charges repel, the diaphragm 2 can vibrate to compress air and generate sound. Notably, since the coil 3 corresponds to the diaphragm 2 in parallel, the current introduced to the coil 3 will generate electromagnetic field with a direction perpendicular to the diaphragm 2, in which the magnetic force will act directly on the diaphragm 2, such that electro-acoustic conversion efficiency is enhanced and minimize the traditional energy loss due to the vibration of the diaphragm initiated by the moving-coil. Moreover, power consumption of the speaker 100 in the instant embodiment is quite low at a same volume (dB value) compared to the conventional moving-coil type speakers. In other words, at a relative similar power, the speaker can produce higher volume.

In summary, the speaker of the instant embodiment includes the diaphragm that has the magnetic layer. The diaphragm possesses magnetism which is different from the conventional materials such as paper, plastics or metallic materials used for a diaphragm. Furthermore, unlike the conventional positioning of the moving-coil, in which the moving-coil is positioned above a support frame and attached to a diaphragm while a magnetic assembly is positioned below the support frame, the magnetic diaphragm of the instant disclosure is positioned above the support frame while the coil is positioned below the support frame. With the aforementioned design, the speaker in the instant disclosure saves space, in which the magnetic assembly is no longer necessary. In addition, the diaphragm and the coil are spaced apart with a gap which can be as narrow as possible there-between, which is different from the conventional moving-coil where it is necessary to maintain a large enough space for the moving-coil to lead the vibration of the diaphragm. With thin film like magnetic diaphragm and the corresponding flat coil design, the overall thickness of the speaker in the instant disclosure effectively reduced to provide a light and thin design, and space is saved that could once be occupied by the conventional magnetic assembly.

The figures and descriptions supra set forth illustrated the preferred embodiments of the instant disclosure; however, the characteristics of the instant disclosure are by no means restricted thereto. All changes, alternations, combinations or modifications conveniently considered by those skilled in the art are deemed to be encompassed within the scope of the instant disclosure delineated by the following claims.

What is claimed is:

1. A speaker, comprising:
a support structure including an upper frame and a lower frame, the upper frame having portions defining an opening thereon;
a diaphragm disposed on the upper frame of the support structure circumscribed by portions defining the opening, the diaphragm having a substrate layer and a magnetic layer formed on a surface of the substrate layer; and
a coil disposed on the lower frame, the coil and the diaphragm arranged opposite to one another and cooperatively defining a gap there-between;
wherein the coil and the diaphragm generates electromagnetic induction in response to electrical current passing through the coil such that the diaphragm vibrates for sound generation.

2. The speaker as recited in claim 1 further comprising:
a surround abutting peripheral portions of the diaphragm and peripheral portions of the support structure defining the opening;

3. The speaker as recited in claim 2, wherein the surround is a silicone, cloth, rubber, or foam surround.

4. The speaker as recited in claim 1, wherein the substrate layer of the diaphragm is made of pulp, cloth, silk, linen, synthetic fibers, ceramics, metals, plastics, or polymers.

5. The speaker as recited in claim 1, wherein the magnetic layer of the diaphragm is made of iron, chromium, cobalt, neodymium, and boron.

6. The speaker as recited in claim 1, wherein the lower frame has a fixing portion arranged at a center portion of the lower frame, and the coil is fixed on the lower frame via the fixing portion.

7. The speaker as recited in claim 1, wherein the coil is a planar coil.

8. The speaker as recited in claim 1, wherein the coil corresponds to the diaphragm in parallel with the relatively gap of a predetermined metering size there-between.

9. A diaphragm arranged in a speaker, comprising:
a substrate layer and a magnetic layer formed on a surface of the substrate layer.

10. The speaker as recited in claim 9, wherein the magnetic layer of the diaphragm is made of iron, chromium, cobalt, neodymium, and boron.

11. A diaphragm arranged in a speaker, comprising:
a sheet of alloy diaphragm made of iron, chromium, cobalt, neodymium, and boron.
